(19) United States
(12) Patent Application Publication
(10) Pub. No.: US 2006/0246784 A1
(43) Pub. Date: Nov. 2, 2006

(54) Electrically isolated shielded connector system

(76) Inventors: Robert A. Aekins, Quaker Hill, CT (US); Robert Hathaway, Ivoryton, CT (US)

Correspondence Address: MCCARTER & ENGLISH LLP;CITYPLACE I, 185 ASYLUM STREET, HARTFORD, CT, 06103, US

(21) Appl. No.: 11/119,116

(22) Filed: Apr. 29, 2005

(51) Int. Cl. H01R 24/00

(52) U.S. Cl. 439/676

(57) ABSTRACT

The present disclosure is related to a multiport adapter for a telecommunication connector system that is designed to reduce EMI from outside sources, as well as, between adjacent ports by electrical isolation design. The reduction of EMI is done by non-conventional methods of connecting hardware shielding techniques. The shield design surrounds all the internal pairs within the plug housing to reduce the transmitted signals EM radiation during transmission and it does not make contact with the modular connector plug, horizontal cable or the plastic support adapter housing. By isolating each component in the interface system, the coupled radiated noise from each port to port shield is individually controlled.

### BACKGROUND OF THE INVENTION

As Unshielded Twisted Pair (“UTP”) cabling continues to be an essential choice of media transmission, new and improved methods must be employed meet the requirements of the transmitting data source. UTP cable is a popular and widely used type of data transfer media. UTP cable is a very flexible, low cost media, and can be used for either voice or data communications. In fact, UTP cable is rapidly becoming the de facto standard for Local Area Networks (“LANs”), other in-building voice, and data communications applications. In an UTP, a pair of copper wires generally forms the twisted pair. For example, a pair of copper wires with diameters of 0.4-0.8 mm may be twisted together and wrapped with a plastic coating to form an UTP. The twisting of the wires increases the noise immunity and reduces the bit error rate (BER) of the data transmission to some degree. In addition, using two wires, rather than one, to carry each signal permits differential signaling to be utilized. Differential signaling is generally immune to the effects of external electrical noise.

The non-use of cable shielding (e.g., a foil or braided metallic covering) in fabricating UTP cable generally increases the effects of outside interference, but also results in reduced cost, size, and installation time of the cable and associated connectors. Additionally, non-use of cable shielding in UTP fabrication generally eliminates the possibility of ground loops (i.e., current flowing in the shield because of the ground voltage at each end of the cable not being the same). Ground loops may give rise to a current that induces interference within the cable, interference against that the shield was intended to protect.

The wide acceptance and use of UTP cable for data and voice transmission is primarily due to the large installed base, low cost and ease of new installation. Another important feature of UTP is that it is used for varied applications, such as for Ethernet, Token Ring, ATM, EIA-232, DSL, analog telephone (POTS), and other types of communication. This flexibility allows the same type of cable/system components (such as data jacks, plugs, cross-patch panels, and patch cables) to be used for an entire building, unlike shielded twisted pair media (“STP”).

At present, UTP cabling is being utilized for systems having increasingly higher data rates. Since demands on networks using UTP systems (e.g., 100 Mbit/s and 1000 Mbit/s transmission rates) have increased, it has become necessary to develop industry standards for higher system bandwidth performance.

UTP systems such as 100 Mbit/s and 1000 Mbit/s transmission rates have produced requirements and specification for cabling transmission such as TIA 568B.2-1, which is basically the standard for category 6 cabling systems. The bandwidth requirements are 1 to 250 MHz. The main parameters are Near-end crosstalk NEXT, Far-end crosstalk FEXT, Equal Level FEXT, Return Loss RL, Attenuation, as well as, crosstalk Powersum parameters PSNEXT and PSELFEXT. From these parameters one of the major contributors is NEXT. What began as the need for connecting hardware to provide near-end cross-talk (“NEXT”) loss of less than −36 dB at 16 MHz, has evolved to −54 dB at 100 MHz and −46 dB at 250 MHz for category 6 systems with future requirements up to 500 MHz. For any data transmission event, a received signal will consist of a transmission signal modified by various distortions. The distortions are added by the transmission system, along with additional unwanted signals that are inserted somewhere between transmission and reception. The unwanted signals are referred to as noise. Noise is the major limiting factor in the performance of today's communication systems. Problems that arise from noise include data errors, system malfunctions, and loss of the desired signals.

Generally, cross-talk noise occurs when a signal from one source is coupled to another line. Cross-talk noise could also be classified as electromagnetic interference (“EMI”). EMI occurs through the radiation of electromagnetic energy. Electromagnetic energy waves can be derived by Maxwell's wave equations. These equations are basically defined using two components: electric and magnetic fields. In unbounded free space a sinusoidal disturbance propagates as a transverse electromagnetic wave. This means that the electric field vectors are perpendicular to the magnetic field vectors that lie in a plane perpendicular to the direction of the wave. NEXT noise is the effect of near-field capacitive (electrostatic) and inductive (magnetic) coupling between source and victim electrical transmissions.

Typical category 5e, 6 and most likely C6 augmented connecting hardware's will incorporate signal feedback techniques called compensation reactance. The use of compensation can decrease the internal noise of NEXT and FEXT, but it can also increase the connecting hardware external noise sources called Alien near-end crosstalk ANEXT and AFEXT and the power summation of these noises.

ANEXT is near-end crosstalk noise that couples from one cabling media to an adjacent cabling media, measured at the near-end or transmitter. AFEXT is far-end crosstalk noise that couples from one cabling media to an adjacent cabling media, measured at the far-end or receiver. Power sum alien near-end crosstalk (PSANEXT) loss is a combination of signal coupling from multiple near-end disturbing cabling pairs into a disturbed pair of a neighboring cabling or part thereof, measured at the near-end. Power sum alien far-end crosstalk (PSAFEXT) loss is a combination of signal coupling from multiple far-end disturbing cabling pairs into a disturbed pair of a neighboring cabling or part thereof, measured at the far-end. IEEE 802.3an 10 Gigabit Ethernet 10 Gbe and the TIA TR42.7 working groups have identified ANEXT and AFEXT as one of the major noise problem that can effect proper 10 Gbe operation over UTP cabling systems with ANEXT being the worse of the two. The initial ANEXT requirement for UTP cabling system, also called Augmented Category 6 UTP is shown in table 1 below:

TABLE 1
ANEXT from TIA 568B.2-A10 draft for Augmented
category 6 100 meters channel link cabling

| MHz | dB |
|---|---|
| 10 | −70 |
| 100 | −60 |
| 250 | −54 |
| 400 | −51 |
| 500 | −49.5 |

Connecting hardware systems that will run 10 Gbe data signals must be designed to meet traditional category 6, as well as, recognized additional 10 Gbe UTP cabling parameters. Due to the adjacency of connecting hardware's in a cabling system, noise sources ANEXT and AFEXT will be present.

One approach to control ANEXT is the usage of a fully shielded cabling system also called Foiled Twisted pair or Screened Twisted pair ScTP. Typical FTP cabling system incorporates metallic shields that are electrically mated to ground either by the transmitting source and/or by the equipment rack ground system. The connector shields are electrically connected together, either externally by mated shield contact or internally by the PCB connection. FTP systems are an effective media for reduction of ANEXT and AFEXT noise sources. Other methods for reducing ANEXT and AFEXT involved mitigation techniques, such as, increasing connector spacing arrangement. Utilizing FTP or mitigation cabling methods provide various issues and increase complexities. In addition, FTP systems are considerably more expensive in material and installation cost. As previously discussed, another issue with FTP is proper installation of system grounds. Poor system grounding can create unwanted ground loops that could lead to increased system noise internally to the transmitter. Mitigation of connectors in many cases is not an option since standard wall outlets (i.e. single gang electrical boxes) and 1 rack unit (typ. 1.5 inch) high mount panels are spaced limited from prior standards.

### SUMMARY OF THE INVENTION

Exemplary embodiments of the invention include a connector including a printed circuit board assembly and an insulated displacement contact terminal in electrical communication with the printed circuit board assembly. A modular insert is in electrical communication with the printed circuit board and adapted to receive a plug. There is also a housing enclosing the modular insert and at least a portion of the housing is metalized and is electrically isolated from at least one of the printed circuit board assembly and external components.

Further exemplary embodiments include a connector panel including a main body having an opening and a plurality of connectors. Each of the plurality of connectors is mounted in a bezel and the bezel is mounted in the opening. The bezel is made of a non-metallic material. Each of the plurality of connectors includes a printed circuit board assembly and an insulated displacement contact terminal in electrical communication with the printed circuit board assembly. A modular insert is in electrical communication with the printed circuit board and adapted to receive a plug. There is also a housing enclosing the modular insert and at least a portion of the housing is metalized and is electrically isolated from at least one of the printed circuit board assembly and external components.

Further aspects, implementations, and advantages of the present invention will become more readily apparent from the description of the drawings and the detailed description of the preferred embodiments of the invention as provided herein below.

### BRIEF DESCRIPTION OF THE DRAWINGS

So that those having ordinary skill in the art to which the disclosed invention appertains will more readily understand how to make and use the same, reference may be made to the drawings wherein:

FIG. 1 is a front perspective view of an assembled connector.

FIG. 2 is an exploded perspective view of the connector of FIG. 1.

FIG. 3 is a rear perspective view of the connector of FIG. 1.

FIG. 4 is an exploded rear perspective view of the connector of FIG. 1.

FIG. 5 is a top side view of the first circuit board used with the exemplary connector of FIG. 1.

FIG. 6 is a bottom side view of the first circuit board used with the exemplary connector of FIG. 1.

FIG. 7 is a pictorial 3D view of a connector arrangement with the connector of FIG. 1.

FIG. 8 is a pictorial view of prior art of a shielded connecting hardware that is electrically connected and grounded.

FIG. 9 is an exemplary embodiment of a housing that isolates a connector from an adjacent connector.

FIG. 10 is another alternative embodiment of a housing that isolates a connector from an adjacent connector.

FIG. 11 shows a graphical illustration of a non isolated connector arrangement PSANEXT of FIG. 8 without ground(s).

FIG. 12 shows a graphical illustration of an isolated connector arrangement PSANEXT of FIG. 9.

### DETAILED DESCRIPTION

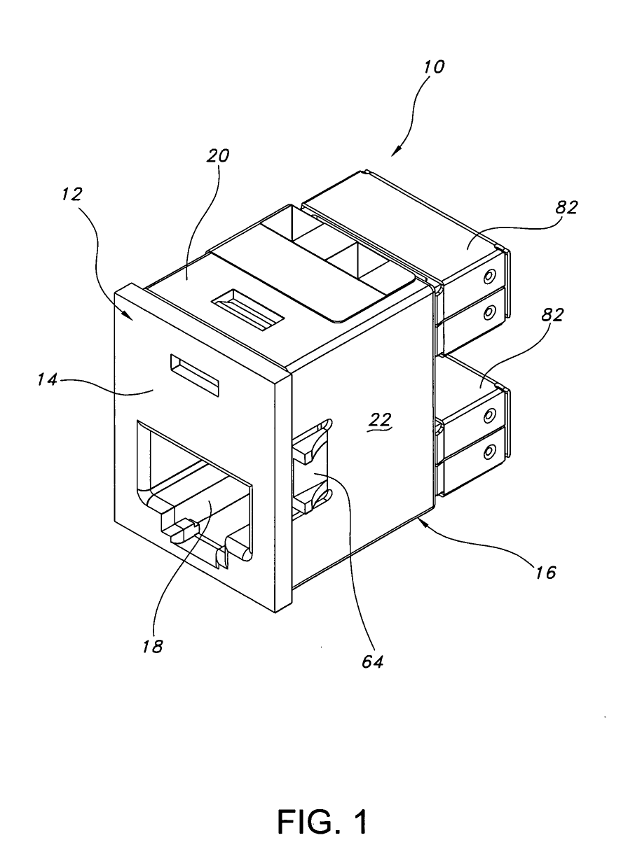

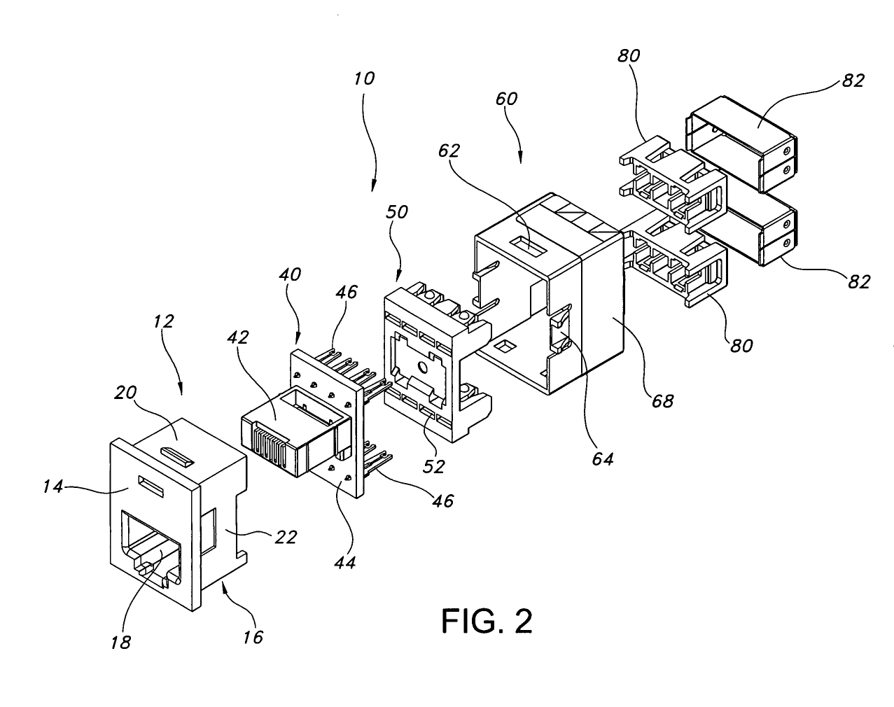

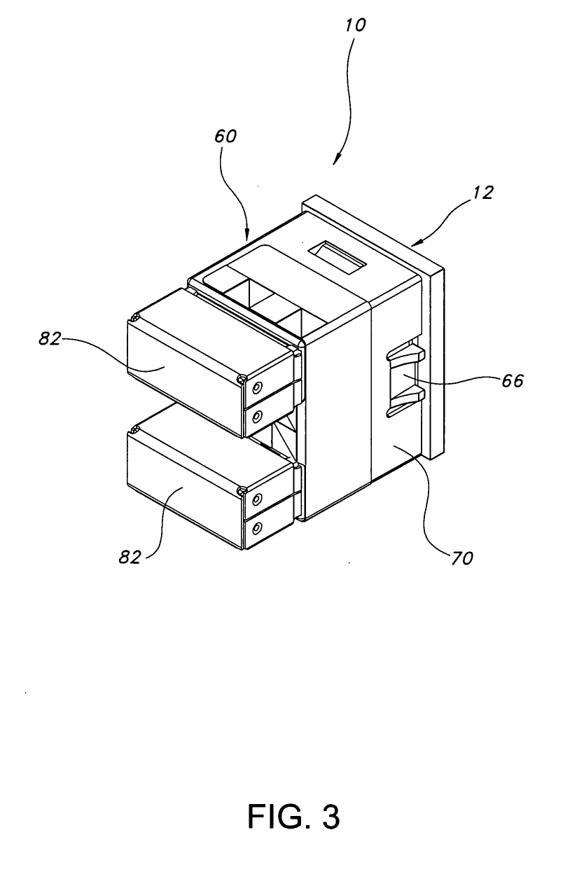

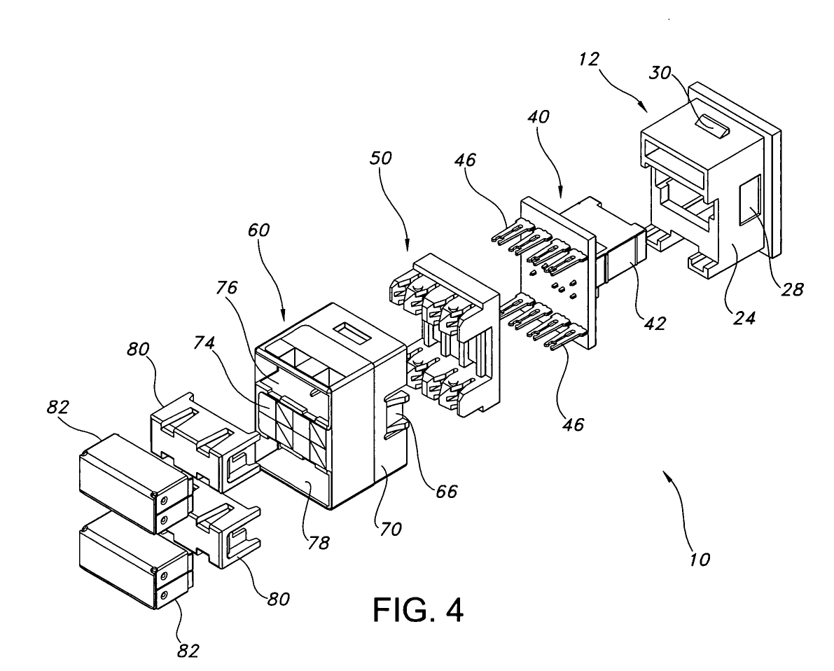

Referring to FIGS. 1-4, a connector 10 is illustrated. Connector 10 includes a front housing 12 that has a front face 14 and a main body 16. Front face 14 has a front opening 18 that is shaped to receive a telecommunication connector (not shown). Main body 16 has four sides (only three are shown) 20, 22, and 24. Sides 22 and 24 each have side openings 26 and 28. Side 20 has a notch 30. A back side 32 includes a back opening 34. Front housing 12 is made of engineering plastics, such as an ABS that is a copolymer of Acrylonitrile, Butadiene, and Styrene. ABS plastics generally possess medium strength and performance and at a reasonable cost that can be color coded to the customer's selection.

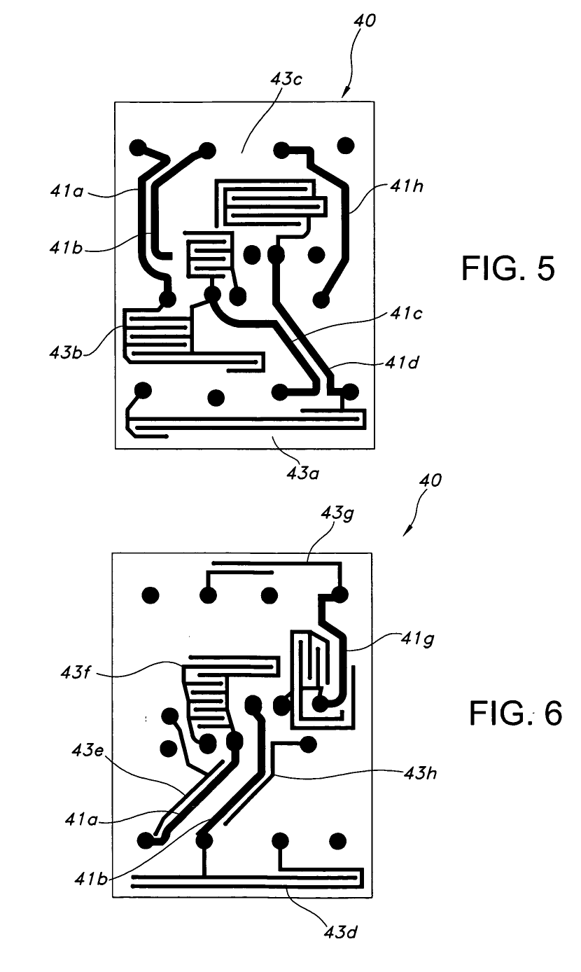

Connector 10 also includes a printed circuit board assembly (PCB) 40 that has a modular insert 42 that is slidably received into back opening 34. Modular insert 42 has a plurality of channel guilds for receiving contacts of the connector. Modular insert 42 contains terminals having 8 lead frames in accordance with most standard wiring formations, such as the T568B and T568A style RJ-45 connectors. It is understood that connector 10 can be sized and configured to receive any type of RJ plug. Modular insert 42 is in electrical communication with a printed circuit board 44 and is also mounted to board 44. FIGS. 5 and 6 illustrate a top side and a bottom side of PCB 40. An exemplary embodiment of PCB 40 is fully disclosed in U.S. Application 2002/0171505, published Nov. 21, 2002, which is incorporated by reference herein in its entirety, and U.S. Pat. No. 6,533,618, issued Mar. 18, 2003, which is incorporated by reference herein in its entirety.

PCB 40 includes a plurality of pins 46 that extend from a rear face 48 of board 44. Pins 46 are in electrical communication with an insulation displacement contact (IDC) terminal 50. IDC terminal 50 includes a plurality of slots 52 that extend outwardly and receives plurality of pins 46. IDC terminal 50 is made from a polycarbonate or other like material.

Referring to FIGS. 5-6, PCB 40 is illustrated in more detail. FIG. 5 illustrates a top side view of the PCB 40 and FIG. 6 illustrates a bottom side view of the PCB 40. PCB 40 a typical 4.1 er, dielectric constant, that is placed inside such the main body 16. The PCB 40 is shown with its compensation reactive circuitry, as explained in U.S. Pat. No. 6,533,618, which is incorporated by reference herein in its entirety. The compensation reactive circuitry's 41a-41h can create and radiate unwanted signals to external and nearby conductive sources, due to their potential antennas like qualities. The other radiated sources are from the signal paths, pair one 43e-f, pair two 43a-b, pair three 43c-b and signal pair four 43g-h.

Referring again to FIGS. 1-4, connector 10 also includes a rear housing 60 that encloses PCB assembly 40 and IDC terminal 50 and mates with front housing 12. Rear housing 60 is metalized, which means that rear housing 60 is either diecast or formed of metal. In addition, rear housing 60 can be formed of plastic, such as an ABS polymer, and the plastic is plated with metal, such as having a copper under flash and a nickel coating. All sides, including the rear side of the rear housing 60 is metalized. Rear housing 60 includes a slot 62 that receives notch 30 of front housing 12. Rear housing 60 also includes notches 64 and 66 located on sides 68 and 70. Notches 64 and 66 are received by side openings 26 and 28 of front housing 12. Notches 30, 64, and 66 secure front housing 12 and rear housing 60 together. Rear housing 60 also includes a back side 74 that has openings 76 and 78.

Connector 10 includes at least one stuffer cap 80 and in an exemplary embodiment has two stuffer caps, as shown in the figures. Stuffer caps 80 are received into openings 76 and 80 of rear housing 60 and receive the extended slots 52 from IDC terminal 50 so as to prevent the wires (not shown) from pulling out of connector 10. Stuffer caps 80 are formed of an insulating material, such as plastic, and may be selectively metalized so as not to ground out connector 10. Alternatively, if stuffer cap 80 is not selectively metalized, each stuffer cap 80 is covered with a stuffer cap shroud 82, which is metalized. This means that shroud 82 is formed of metal or is formed of plastic and then plated with metal. All four sides and the rear of the stuffer cap shroud is metalized. In addition, stuffer caps 80 may be selectively metalized and metalized shrouds 82 may also be utilized.

Connector 10 operates as follows. A plug (not shown), which is attached to a cable (not shown), is inserted into front opening 18 of front housing 12. The contacts of the plug mate with the contacts of modular insert 42. The signal from the cable is transmitted through the plug and modular inserts 42 into PCB assembly 40. The signal is transferred from the PCB assembly 40 to IDC terminal 50, which is connected to a second cable, thus completing the data interface and transfer through the connector 10. By metalizing rear housing 60 and stuffer cap shrouds 82, and selectively metalizing stuffer caps 80, connector 10 becomes insulated from adjacent connectors and alien cross talk is reduced from connector to connector. In addition, it is understood that the metalized housing is not meant to be a conductive path from the shield in an FTP cable; instead, the metalized housing, which includes the rear housing 60, stuffer cap shroud 82, and the selectively metalizing stuffer cap 80 functions as a floating shield and does not conduct electricity.

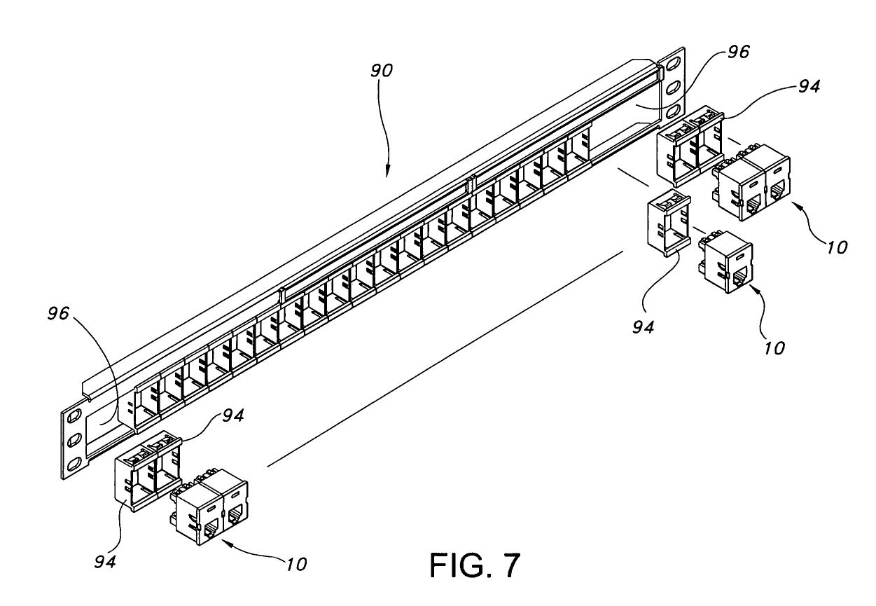

FIG. 7 illustrates connector 10 mounted in a connector panel 90, which is mountable to an equipment rack (not shown). Connector panel 90 receives a plurality of connectors 10, which are received into a bezel 94 for mounting in connector panel 90. Bezels 94 made of a non-metallic material and provide isolation from connector to connector in panel 90. The connector 10 is snapped into bezel 94, which is then assembled into an opening 96 in connector panel 90. Connectors 10/bezels 94 can be single or multi-gang piece assemblies. Each connector 10 mounts to a bezel 94. Another option for providing shield isolation from connector to connector is to selectively plate the connector housing with metal in locations that are adjacent to nearby connectors and in which there is no direct contact between connectors.

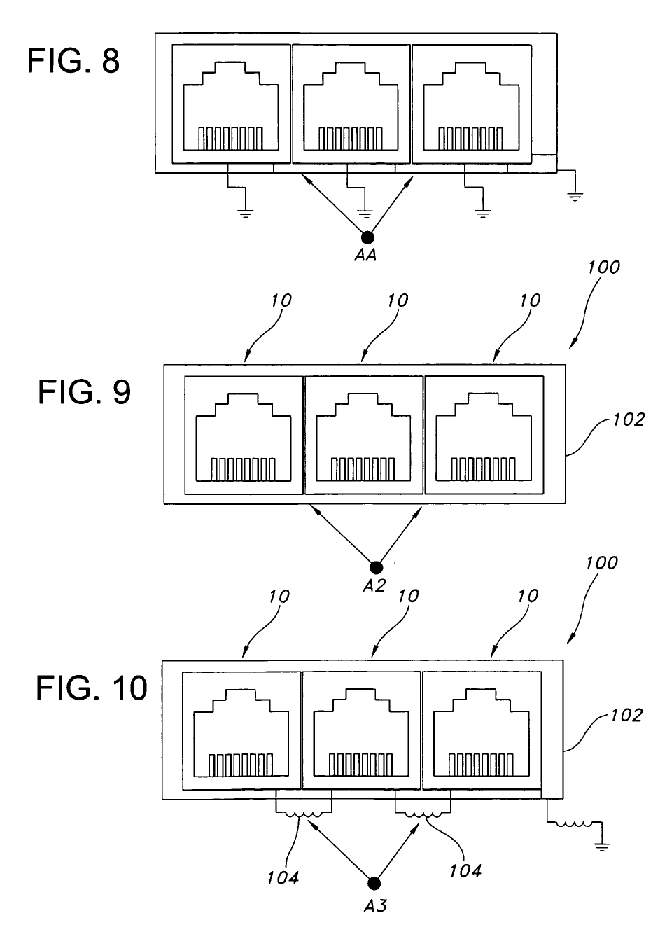

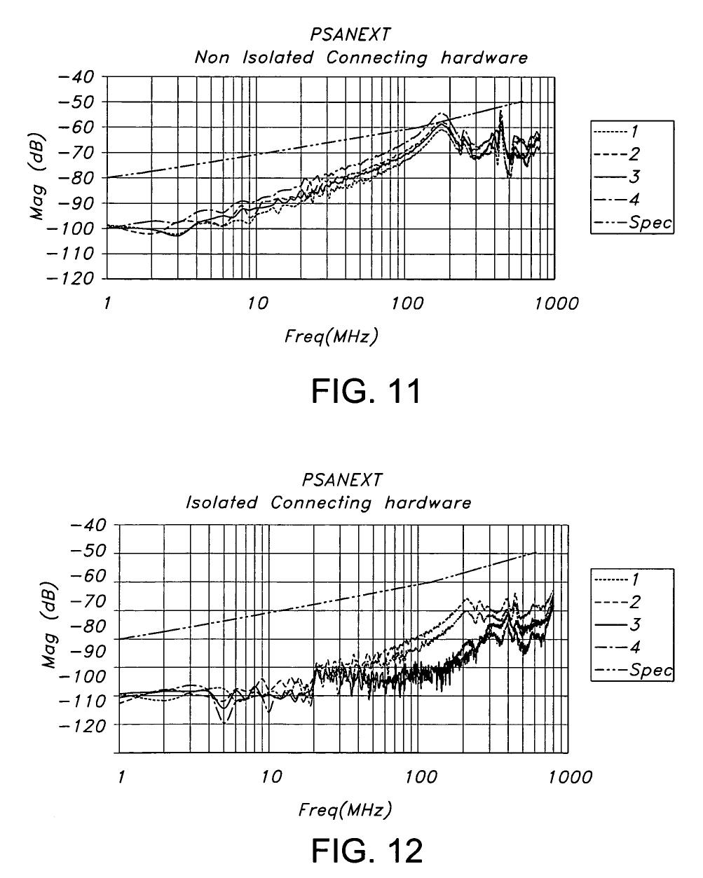

FIGS. 9 and 10 illustrate a device 100 having a metal housing 102 and plurality of connectors 10 assembled in housing 102. It is understood that an exemplary embodiment of housing 102 includes connector panel 94 and that housing 102 also includes any other type of housing for connectors. Device 100 illustrates the electrical isolation that occurs between each connector 10. These figures can be compared to FIG. 8, which illustrates the prior art connectors in which each connector is not electrically isolated from the adjacent connector. Graphically, the benefits of the isolated connector of FIG. 9 are illustrated in FIG. 12, as compared to a connector with no isolation, which is illustrated in FIG. 11. The limit line equation is from the 568B.2-A10 draft for augmented category 6 and is a proposed requirement for 10 Gbe transmission over UTP cabling systems. As illustrated, the isolated connector stays within the defined specifications.

FIG. 9 illustrates the metallic housing 102 electrically isolated from other metallic housing by non-metallic materials, such as ABS materials, to better control ANEXT and AFEXT of a connecting hardware. In an exemplary embodiment, the non-connected shield (isolated) is composed of a dielectric support member having a metallic and electrically conductive material. The shielding material typically will provide greater than 60 dB of shielding effectiveness from 1 to 500 MHz. Each isolated shield connector member generally includes a contact portion, which is exposed in the receiving space of the modular housing for making electrical contact with the media plug contacts, and a rear portion with Insulation Displacement Contacts IDC for mating with UTP wires, thus completing the input to output media connecting. The isolated shield connectors are in a positional relationship with respect to each other that substantially reduces and/or removes electrical noise. It is also understood that the isolated shield of connector is electrically isolated from the internal circuitry PCB, IDC and modular plug. Another embodiment of the device 100, but not shown, is multiple metallic housing that are isolated and placed onto a printed circuit board. The metallic housings are, but not limited to, held in place by a non-metallic structure. Each individual housing is isolated but designed as one multi-port device that allow for reduced production piece cost and end-user installation.

FIG. 10 illustrates another embodiment of device 100 in which the connectors 10 are partially isolated and illustrates an RF choke 104. In this embodiment, connector to connector isolation can is achieved by implementing high frequency impedance device EMI chokes or ferrite beads. The usage of a high frequency impedance device, such as a ferrite core, will appear as an electrical short at low frequencies and as high impedance at high frequencies. The high frequency impedance device should have suppression materials that will increase in impedance starting at 20 MHz up to 500 MHz. Typical materials, but not limited to, are ferrite core Nickel Zinc NiZn number 43, 44 and 61 such as manufactured by the Fair-Rite Corporation. By adding a high frequency impedance device, this allows partial isolation since it essentially blocks out high frequencies, and thus reduces the sheild to shield radiated coupling from the connectors therefore decreasing ANEXT. The usage of a high frequency impedance device and the positional relationship of this device, provide essentially high frequency isolation and allow grounding of low frequency responses.

In addition, an isolated connector system, being of twisted pair cable, patch cord and connecting hardware with individual metallic housing for data/voice systems is provided that will not deform the wire pairs in a standard EIA T568B style wire configuration and is simple, low cost and easy to implement cabling system. Preferred installation of the isolated connector system is the same as standard UTP installations.

Devices and/or systems according to the present disclosure include a non-connected shield (isolated) connecting hardware system for data signal transmissions by interfacing with a media plug.

The invention takes a hybrid approach of solving a problem for 10 Gbe UTP cabling system. The hybrid method involves properly utilizing two media concepts to produce one unit, UTP with isolated shielded interfacing. Cabling systems are typically composed of network HUB {*patch cords→Cross-connect connection→up to 90 m horizontal cable→Telecommunication Outlet (“TO”)→patch cord→} Computer, {*} as defined by the TIA/EIA 568.B.2-1 Commercial Building Telecommunication Cabling Standard. Cross-connects and occasionally TO for shielded systems are typically horizontally or vertically multi-gang connectors placed in a single metalized holding unit. The holding units are metalized to provide electrically grounded connections to all connectors that are placed inside. The invention involves modification of connection points, the Cross-connect and TO within the cabling system.

Each connector 10 is internally separated by a metallic enclosure system that is also electrically isolated from each other. The metallic cavity design surrounds all the internal pairs within the plug housing to reduce the transmitted signals EM radiation during transmission and it does not make contact with the modular connector plug, horizontal cable or the plastic support adapter housing. By isolating each component in the interface system the radiated noise from each port is individually controlled by coupling reduction. The initial benefit is the reduction of the internal signal EMI field because of the metallic shields SE value. The SE being the Shielding Effectiveness of the metallic material provides an effective barrier against internal, as well as, external noise sources. The isolated cavity reduces the mutually inductive noises that have been radiated or coupled onto the shield to those coupled onto an adjacent shield. The metallic enclosure provides a shielded barrier against adjacent ports transmitting signal noises.

Another aspect of the present disclosure is achieving high frequency connector to connector isolation in a UTP cabling system. To achieve high frequency isolation between connectors the usage of high frequency impedance device, Ferrite beads or RF chokes, are electrically connected between each housing of a connector. Ferrite beads are comprised of several material types and frequency characteristics that provide a broad range of impedance values for noise suppression applications. For the 10 Gbe UTP cabling limits 1 to 500 MHz is the bandwidth requirement. As the frequencies increase into the upper bandwidth ranges >200 MHz radiated noises coupled onto the surrounding shields and if that shield in electrically mated to an adjacent shield, then its noise its induced into the adjacent connector. The usage of Ferrite bead for electrically mating of shields also provide external as well as, internal EMI shielding benefits. Since each connector is connected electrically by a high frequency impedance device, the external noise that is coupled into one connector in not internally coupled into adjacent connectors. By reducing high frequency shield coupling, connector ANEXT will be significantly reduced for improved operation of UTP 10 Gbe data signal in a UTP cabling system.

The benefit of reducing the connector transmitted signal EM noise is reduction in Port to Port Near-end crosstalk or also called Alien Near-end crosstalk (ANEXT), that can be a problem in high speed networks such as 10 Gigabit Ethernet (10GBASE-T). Isolation can also be achieved by the addition of high frequency impedance device EMI Inductive source between ports to provide a common ground reference.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

1. A connector comprising:
a printed circuit board assembly;
an insulated displacement contact terminal in electrical communication with the printed circuit board assembly;
a modular insert in electrical communication with the printed circuit board and adapted to receive a plug;
a housing enclosing the modular insert, at least a portion of the housing is metalized and is electrically isolated from the printed circuit board assembly and external components, wherein the housing is floating relative to ground.

2. The connector of claim 1, wherein the plug is a RJ plug.

3. The connector of claim 1, wherein the housing includes a front housing and a rear housing, the rear housing is metalized, the front housing includes an opening to receive a connector.

4. The connector of claim 3, wherein the opening is sized to receive a RJ-45 plug.

5. The connector of claim 3, wherein the front housing is made of plastic.

6. The connector of claim 3, wherein the rear housing is formed of a metal.

7. The connector of claim 3, wherein the rear housing is formed of plastic and the plastic is plated with metal.

8. The connector of claim 1, further comprising a stuffer cap coupled to the insulated displacement terminal.

9. The connector of claim 8, wherein the stuffer cap is selectively metalized.

10. The connector of claim 8, wherein the stuffer cap is enclosed with a stuffer cap shroud, the stuffer cap shroud is metalized.

11. A connector of claim 1, wherein the connector is electrically isolated from an adjacent connector.

12. A connector of claim 1, wherein a high frequency impedance of the connector is electrically isolated from an adjacent connector.

13. A connector of claim 1, wherein the housing encloses the printed circuit board assembly and the insulated displacement contact terminal.

14. A connector panel comprising:
a main body having an opening;
a plurality of connectors, each of the plurality of connectors is mounted in a bezel and the bezel is mounted in the opening, the bezel is made of a non-metallic material,
each of the plurality of connectors includes:
a printed circuit board assembly;
an insulated displacement contact terminal in electrical communication with the printed circuit board assembly;
a modular insert in electrical communication with the printed circuit board and adapted to receive a plug;
a housing enclosing the modular insert, at least a portion of the housing is metalized and is electrically isolated from the printed circuit board assembly and external components, wherein the housing is floating relative to ground.

15. The connector panel of claim 14, wherein the housing includes a front housing and a rear housing, the rear housing is metalized, the front housing includes an opening to receive a connector.

16. The connector panel of claim 14 wherein the plug is a RJ plug.

17. The connector of claim 14 further comprising a stuffer cap coupled to the insulated displacement terminal.

18. The connector of claim 17, wherein the stuffer cap is selectively metalized.

19. The connector of claim 17, wherein the stuffer cap is enclosed with a stuffer cap shroud, the stuffer cap shroud is metalized.

20. The connector of claim 14, wherein the connector is electrically isolated from an adjacent connector.

21. A connector of claim 14, wherein a high frequency impedance of the connector is electrically isolated from an adjacent connector.
